(19) United States
(12) Patent Application Publication
(10) Pub. No.: US 2019/0284956 A1
(43) Pub. Date: Sep. 19, 2019

(54) Casing Of A Turbocharger And Turbocharger

(71) Applicant: MAN ENERGY SOLUTIONS SE, Augsburg (DE)

(72) Inventors: Harald DENKEL, Baar (DE); Steffen BRAUN, Augsburg (DE); Daniel ALBRECHT, Augsburg (DE); Stefan WEIHARD, Augsburg (DE); Bernd HAAS, Neusass (DE); Johannes NIEBUHR, Augsburg (DE); Urban SPATZ, Neusass (DE)

(21) Appl. No.: 16/352,305

(22) Filed: Mar. 13, 2019

(30) Foreign Application Priority Data
Mar. 14, 2018 (DE) DE102018105827.6

(51) Int. Cl. F01D 21/04; F01D 25/24

(52) U.S. Cl. CPC F01D 21/045; F05D 2220/40; F05D 2240/14; F01D 25/24

(57) ABSTRACT

A casing of a turbocharger, surrounding a turbine, compressor, and/or a bearing housing of the turbocharger at least in sections, with axial casing segments that adjoin the housing axially outside, and with radial casing segments that adjoin the housing to be encased radially outside. An additional casing segment encloses or completes the axial casing segments and/or the radial casing segments in the region of an inlet flange or outlet flange of the housing.

### BACKGROUND OF THE INVENTION

### 1. Field of the Invention

The invention relates to a casing of a turbocharger and to a turbocharger.

### 2. Description of the Related Art

The fundamental construction of a turbocharger is known to the person skilled in the art addressed here. A turbocharger comprises a turbine in which a first medium is expanded a compressor in which a second medium is compressed, namely utilising energy extracted in the turbine during the expansion of the first medium. The turbine of the turbocharger comprises a turbine housing and a turbine rotor. The compressor of the turbocharger comprises a compressor housing and a compressor rotor. Between the turbine housing of the turbine and the compressor housing of the compressor a bearing housing is positioned, wherein the bearing housing is connected on the one hand to the turbine housing and on the other hand to the compressor housing. In the bearing housing, a shaft is mounted via which the turbine rotor is coupled to the compressor rotor.

During operation of a turbocharger there is a risk that a rotor, for example the turbine rotor or the compressor rotor of the turbocharger, breaks and fragments of the rotor strike through the relevant housing, i.e. the turbine housing or the compressor housing. There is then the risk that the fragments of the turbocharger, in particular of the rotor, enter the surroundings. In order to take into account this problem of the bursting of a rotor of the turbocharger, the respective housing in turbochargers known from practice is designed in such a manner that a failure of the respective housing need not be expected and even in the event of a breaking of the respective rotor, fragments of the same cannot strike through the respective housing. However, this increases a weight of the turbocharger.

To avoid unnecessarily increasing the weight of the turbocharger and additionally protect turbochargers that are already employed in the field from fragments of a rotor striking through into the surroundings it is already known from practice to equip a turbocharger with a casing that surrounds a turbine housing and/or a compressor housing and/or a bearing housing of the turbocharger radially outside and axially outside at least in sections.

Casings for turbochargers known from practice comprise axial casing elements, which on the sides of the housing to be encased, adjoin the housing to be encased axially outside. Furthermore, casings known from practice comprise radial casing elements which adjoin the housing to be encased radially outside. The radial casing elements have ends which are located opposite one another, which define a recess for the passage of an inlet flange or outlet flange of the housing to be encased. In this position, casings known to date have a weak point so that via this position fragments of the rotor can reach outside into the surroundings in the event of a failure. This is disadvantageous.

### SUMMARY OF THE INVENTION

One aspect of the invention is based on creating a new type of casing of a turbocharger and a turbocharger having such a casing.

The casing according to one aspect of the invention comprises an additional casing segment that encloses and/or completes the axial casing segments and/or the radial casing segments in the region of an inlet flange or outlet flange of the housing to be encased at least in sections.

The weak point on casings known to date is closed via the additional casing segment. The additional casing segment encloses and/or completes the axial casing elements and/or the radial casing elements in the region of the passage opening for the inlet flange or outlet flange at least in sections. In particular, a containment protection or burst protection that can be provided by the casing can be increased.

Preferentially, the radial casing segments comprise ends that are located opposite one another, which define a recess for the inlet flange or outlet flange of the housing to be encased, wherein these ends of the radial casing segments located opposite one another are connected by the additional casing segment. By way of this, the containment protection or burst protection that can be provided by the casing can be particularly advantageously increased.

Preferentially, the additional casing segment comprises an enclosure section, which at a first end of the radial casing segments adjacently to the inlet flange or outlet flange encloses and completes the axial casing segments and/or the radial casing segments in sections. In the region of the first end of the radial casing segments, the additional casing segment is connected to the radial casing segments and/or axial segments via the enclosure section. Starting out from the enclosure section of the additional casing segment, fastening sections of the additional casing segment extend in the direction of the second end of the radial casing segments. By way of the fastening sections, the additional casing segment is connected to the axial casing segments and/or in the region of the second end of the radial casing segment, to the radial casing segments. These features also serve for the particularly advantageous increasing of the containment protection or burst protection that can be provided by the casing.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Preferred further developments of the invention are obtained from the subclaims and the following description. Exemplary embodiments of the invention are explained in more detail by way of the drawing without being restricted to this.

There it shows:

FIG. 1 is a perspective view of a casing for a turbocharger according to the invention;

FIG. 2 is the casing of FIG. 1 with a housing of the turbocharger to be encased;

FIG. 3 is the arrangement of FIG. 1 without additional casing segment;

FIG. 4 is an extract from the casing of FIG. 1 in lateral view; and

FIG. 5 is a cross section by way of extract through the casing of FIG. 1.

### DETAILED DESCRIPTION OF THE PRESENTLY PREFERRED EMBODIMENTS

The invention relates to a casing of a turbocharger and to a turbocharger having a casing.

The fundamental construction of a turbocharger is familiar to the person skilled in the art addressed here. Accordingly, a turbocharger comprises a turbine for expanding a first medium, in particular for expanding exhaust gas, and a compressor for compressing a second medium, in particular for compressing charge air, namely utilising energy extracted in the turbine during the expansion of the first medium. The turbine comprises a turbine rotor and a turbine housing. The compressor comprises a compressor rotor and a compressor housing. The turbine rotor and the compressor rotor are coupled via a shaft, which is mounted in a bearing housing of the turbocharger, wherein the bearing housing is connected both to the turbine housing and also to the compressor housing.

In particular when during the operation for example the turbine rotor or the compressor rotor breaks, fragments of the same can strike through the respective housing, i.e. the turbine housing or the compressor housing and enter the surroundings. This has to be avoided for the purpose of which it is known to equip a turbocharger with a casing that surrounds the turbine housing and/or the compressor housing and/or the bearing housing of the turbocharger.

Preferentially, a separate casing is employed in the region of the turbine housing and the compressor housing in each case, which surrounds the respective housing of the turbocharger to be encased radially outside and axially outside at least in sections.

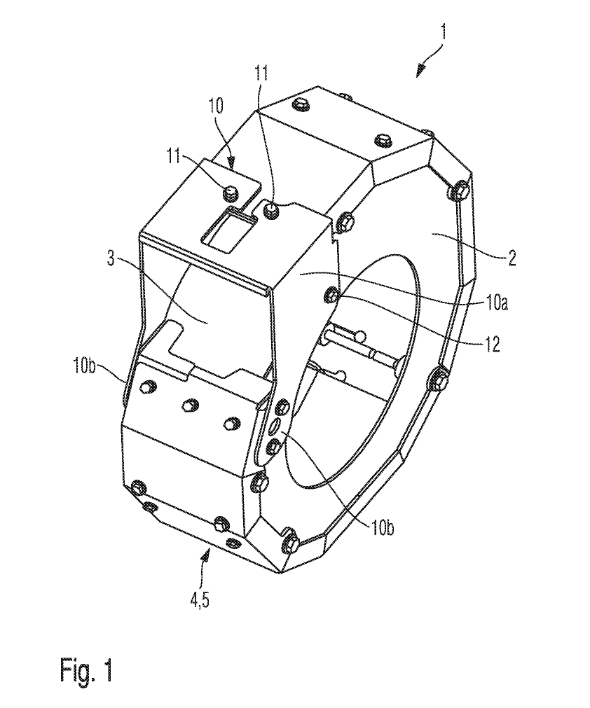

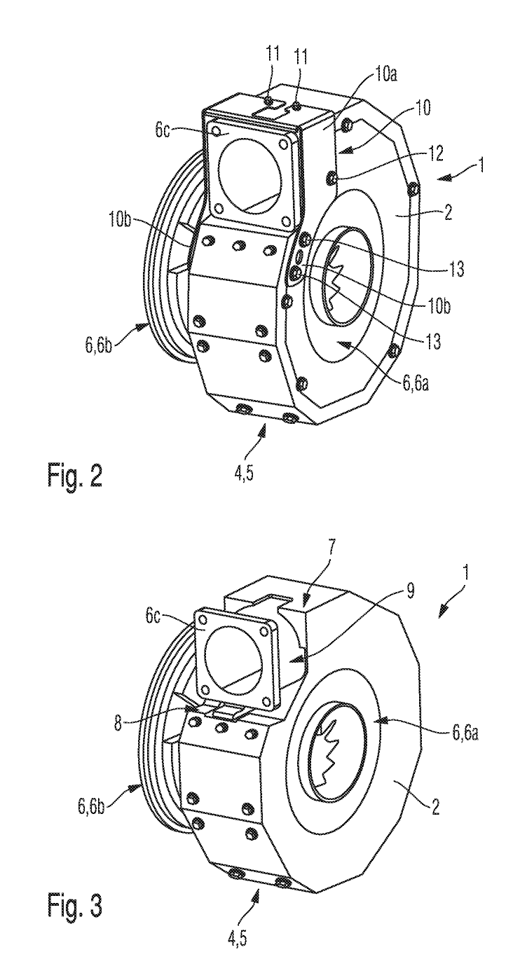

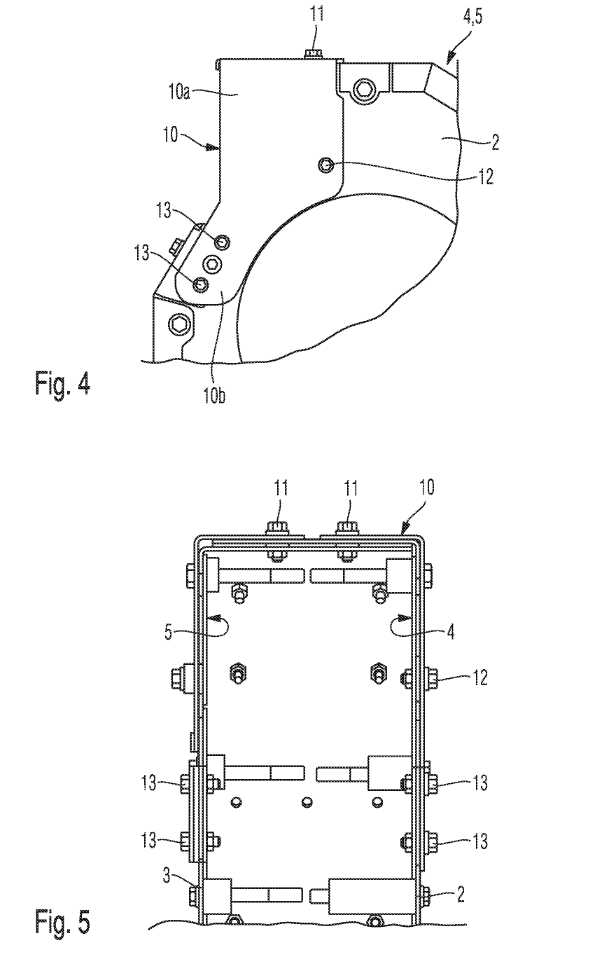

FIGS. 1 to 5 show a casing 1 according to the invention, wherein in FIGS. 2 and 3 the casing 1 according to the invention is shown together with a turbine housing 6 of a turbine of the turbocharger to be encased. Here, the casing 1 is arranged about a turbine inflow housing 6a of the turbine housing 6 at least in sections. Accordingly, the casing surrounds the turbine inflow housing 6a of the turbine housing 6 to be encased outside at least in sections. FIGS. 2 and 3, furthermore, show a turbine outflow housing 6b of the turbine housing 6.

Furthermore, FIGS. 2 and 3 show an inlet flange 6c of the turbine inflow housing 6a. Via this inlet flange 6c, the turbine inflow housing 6a can be connected to an exhaust line in order to feed hot exhaust gas, which is to be expanded in the turbine, to the turbine inflow housing 6a.

The casing 1 comprises axial casing segments 2, 3, which are arranged axially outside laterally next to the housing 6a to be encased and adjoin the housing 6a to be encased axially outside and axially cover the same at least in sections.

Furthermore, the casing 1 comprises radial casing segments 4, 5, which adjoin the housing 6a to be encased radially outside and surround the same radially outside at least in sections. The radial casing segments 4, 5 substantially extend between the axial casing segments 2 and 3.

In particular it is provided that a first radial casing segment 4 is connected to a first axial casing segment 2 and, emanating from this first axial casing segment 2, extends in the direction of a second axial casing segment 3. A second radial casing segment 5, which, emanating from the second axial casing segment 3, extends in the direction of the first axial casing segment 2, is connected to the second axial casing segment 3.

The radial casing segments 4 and 5 form ends 7, 8 located opposite one another as is best evident from FIG. 3. Between these ends 7, 8 that are located opposite one another of the radial casing segments 4, 5 a recess 9 for the passage of the inlet flange 6c of the housing 6a to be encased is formed. In the region of this inlet flange 6c, the housing 6a to be encased is not covered or surrounded by the radial casing segments 4, 5 and the axial casing segments 2, 3 so that the casing 1 would have a weak point here.

To close this weak point, according to one aspect of the invention, the casing 1 comprises an additional casing segment 10. The additional casing segment 10 encloses and/or completes the axial casing segments 2, 3 and/or the radial casing segments 4, 5, in the region of the inlet flange 6c or adjoining the inlet flange 6c of the housing 6 to be encased at least in sections and thus increases the burst protection or containment protection that can be provided by the casing.

The additional casing segment 10 connects the ends 7, 8 of the radial casing segments 4, 5, which define the passage opening 9 for the inlet flange 6c of the housing 6a to be encased with one another and thus increases the containment protection or burst protection in a particularly advantageous manner.

The additional casing segment 10 comprises an enclosure section 10a. The enclosure section 10a completes and encloses the axial casing segments 2, 3 and the radial segments 4, 5 at a first end 7 of the radial casing segments 4, 5 adjoining the inlet flange or outlet flange. This enclosure section 10a is connected via first fastening elements 11 to the first end 7 of the radial casing segments 4, 5 and via second fastening elements 12 to an adjoining region of the axial casing segments 2, 3. According to FIG. 2, the enclosure section 10a of the additional casing segment 10 encloses the casing segments 2, 3, 4, and 5 adjoining the inlet flange 6c of the housing 6a to be encased on three sides.

Starting out from the enclosure section 10a of the additional casing segment 10, fastening sections 10b extend laterally in the direction of the second end 8 of the radial segments 4, 5. In the region of the second end 8 of the radial casing segments 4, 5, the additional casing segment 10 is connected to the radial casing segments 4, 5 and/or the axial casing segments 2, 3 in a region adjacent thereto via second fastening elements 13.

With the invention present here, the containment protection or burst protection that can be provided by a casing can be significantly increased. In particular there, where the casing comprises a recess for the passage of an inlet flange or outlet flange of a housing to be encased, the burst protection or containment protection can be significantly increased.

The additional casing segment 10 of the casing 1 utilised for increasing the burst protection or containment protection can be embodied in one piece or multiple parts.

In the region of a recess for the passage of the inlet flange or outlet flange of the housing to be encased, the additional casing segment 10 encloses and/or completes the casing 1. Particularly preferably, ends, which delimit the recess for the passage of the inlet flange or outlet flange, are connected to one another by the additional casing segment, as a result of which the containment protection can be further increased. The additional casing segment 10 reinforces the casing 1 in the region of a recess 9 for the passage of the inlet flange or outlet flange of the housing to be encased in the manner of a ruff collar.

The invention, furthermore, relates to a turbocharger having such a casing which is preferentially arranged about a turbine inflow housing of a turbine housing of a turbine of the turbocharger. However, the casing can also be employed in the region of a compressor housing of the turbocharger.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A casing of a turbocharger, configured to surround a housing at least in sections, comprising:
axial casing segments configured to adjoin the housing to be encased axially outside
radial casing segments configured to adjoin the housing to be encased radially outside;
an additional casing segment configured to enclose and/or complete at least one of the axial casing segments and the radial casing segments in a region of an inlet flange or outlet flange of the housing to be encased.

2. The casing according to claim 1,
wherein the radial casing segments have ends located opposite one another, which define a recess for the inlet flange or the outlet flange of the housing to be encased, and
wherein the ends of the radial casing segments that are located opposite one another are connected by the additional casing segment.

3. The casing according to claim 1, wherein the additional casing segment comprises an enclosure section, which at a first end of the radial casing segments encloses and completes the axial casing segments and/or the radial casing segments in sections.

4. The casing according to claim 3, wherein the additional casing segment is connected via the enclosure section in a region of the first end of the radial casing segments to the radial casing segments.

5. The casing according to claim 4, wherein the additional casing segment is connected to the axial casing segments via the enclosure section.

6. The casing according to claim 3, wherein the enclosure section encloses the radial casing segments and the axial casing segments on three sides in sections.

7. The casing according to claim 3, wherein fastening sections extend in towards a second end of the radial casing segments from the enclosure section.

8. The casing according to claim 7, wherein the additional casing segment is connected to the radial casing segments via the fastening sections in the region of the second end of the radial casing segments.

9. The casing according to claim 8, wherein the additional casing segment is connected to the axial casing segments via the fastening sections.

10. The casing according to claim 1, wherein the housing to be encased is one or more of a turbine housing, a compressor housing, and a bearing housing of the turbocharger.

11. A turbocharger,
a turbine housing;
a turbine configured to expand a first medium arranged in the turbine housing;
a compressor housing;
a compressor configured to compress a second medium utilising energy extracted in the turbine during expansion of the first medium arranged in the compressor housing;
a bearing housing arranged between and connected to the turbine housing and the compressor housing;
a respective casing surrounding at least one of the turbine housing, the compressor housing, and the bearing housing radially outside and axially outside at least in sections comprising:
axial casing segments configured to adjoin the housing to be encased axially outside
radial casing segments configured to adjoin the housing to be encased radially outside;
an additional casing segment configured to enclose and/or complete at least one of the axial casing segments and the radial casing segments in a region of an inlet flange or outlet flange of the housing to be encased.
